(19) United States
(12) Patent Application Publication
(10) Pub. No.: US 2018/0343724 A1
(43) Pub. Date: Nov. 29, 2018

(54) SENSOR WITH A LIGHT SIGNAL MODULE

(71) Applicant: KITA SENSOR TECH. CO., LTD., New Taipei City (TW)

(72) Inventors: Chao-Lin CHEN, Taipei City (TW); Min Lwin MAO, Kumamoto City (JP)

(21) Appl. No.: 15/959,134

(22) Filed: Apr. 20, 2018

(30) Foreign Application Priority Data
May 26, 2017 (TW) 106117527
May 26, 2017 (TW) 106207571

(51) Int. Cl. H05B 37/02; F21V 1/14; G01D 11/24; G01D 7/00

(52) U.S. Cl. CPC H05B 37/0227; G01D 7/005; G01D 11/245; F21V 1/14

(57) ABSTRACT

A sensor is provided to measure an operating parameter of an object, and includes a sensor module disposed in a housing and configured to detect the object and to send a measured information so as to produce an instruction set corresponding to the measured information, and a light signal module disposed in the housing and electrically connected with the sensor module. The light signal module is actuated by the instruction set to emit light therefrom, and has front and lateral light emitting surfaces respectively facing two different directions. Therefore, a user can easily observe the light emitting from the front and lateral light emitting surfaces.

### CROSS-REFERENCE TO RELATED APPLICATION

This application claims priority of Taiwanese Patent Application No. 106117527, filed on May 26, 2017, and Taiwanese Patent Application No. 106207571, filed on May 26, 2017.

### FIELD

The disclosure relates to a sensor, and more particularly to a sensor with a light signal module having multi-directional light emitting surfaces.

### BACKGROUND

In the manufacturing process of semiconductors, sensing and monitoring of the flow rate and the pressure of a fluid are required to ensure normal operation of a machine (such as robotic arm, vacuum chuck, etc.), and conventional flow meters and manometers are utilized as monitoring devices. These monitoring devices generally include a warning light at a front side thereof to be seen by a user for alarming the user when the operation of the machine is not normal (for example, when the flow rate or the pressure of the fluid flowing in the machine is not within a certain range). However, it is not easy to see the warning light when the user moves around and is not in front of the machine, and the user may not be able to respond to an abnormal operation promptly.

### SUMMARY

Therefore, an object of the disclosure is to provide a sensor that can alleviate at least one of the drawbacks of the prior art.

According to the disclosure, a sensor is provided to measure an object, and includes a housing, a sensor module and a light signal module. The sensor module is disposed in the housing, and is configured to detect the object and to send a measured information so as to produce an instruction set corresponding to the measured information. The light signal module is disposed in the housing, and is electrically connected with the sensor module. The light signal module is actuated by the instruction set to emit light therefrom. The light signal module has a front light emitting surface and a lateral light emitting surface which respectively face two different directions from each other. Therefore, a user can easily observe the light emitting from the front and lateral light emitting surfaces of the light signal module.

### BRIEF DESCRIPTION OF THE DRAWINGS

Other features and advantages of the disclosure will become apparent in the following detailed description of the embodiments with reference to the accompanying drawings, of which:

FIG. 1 is an exploded perspective view illustrating a first embodiment of a sensor according to the disclosure, and an upright wall where the sensor is to be mounted;

FIG. 2 is a perspective view of FIG. 1;

FIG. 3 is a perspective view of the first embodiment;

FIG. 4 is a perspective view of the first embodiment, seen from another angle;

FIG. 5 is a fragmentary sectional view illustrating a sensor module of the first embodiment;

FIG. 6 is a fragmentary sectional view illustrating a light signal module of the first embodiment;

FIG. 7 is a perspective view similar to FIG. 2, a front protective cover thereof being removed therefrom for the sake of clarity;

FIG. 8 is a perspective view of a second embodiment of the sensor according to the disclosure;

FIG. 9 is a sectional view of the second embodiment; and

FIG. 10 is a perspective view of a modified form of the sensor according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

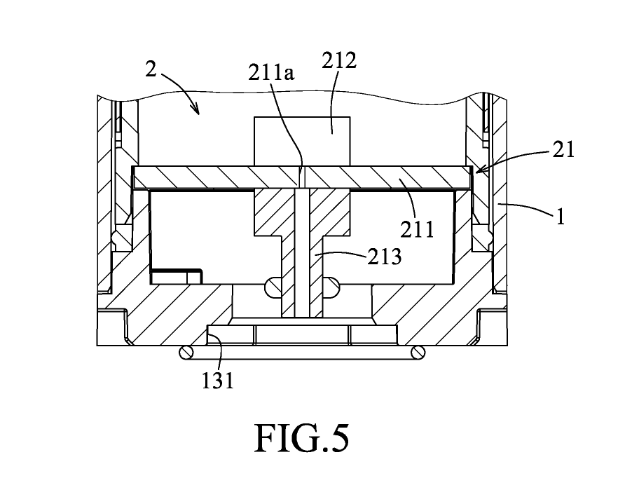

Referring to FIGS. and 2, a first embodiment of the sensor 10 according to the disclosure is adapted to be mounted on an upright plate wall 8 which has a mounting hole, and is disposed for measuring an operating parameter an object (not shown). The operating parameter is, for example, flow rate or pressure of a fluid flowing in the object. The sensor 10 includes a housing 1, a sensor module 2 (see FIG. 5), a light signal module 3, a fastening unit 6 and a front protective cover 7.

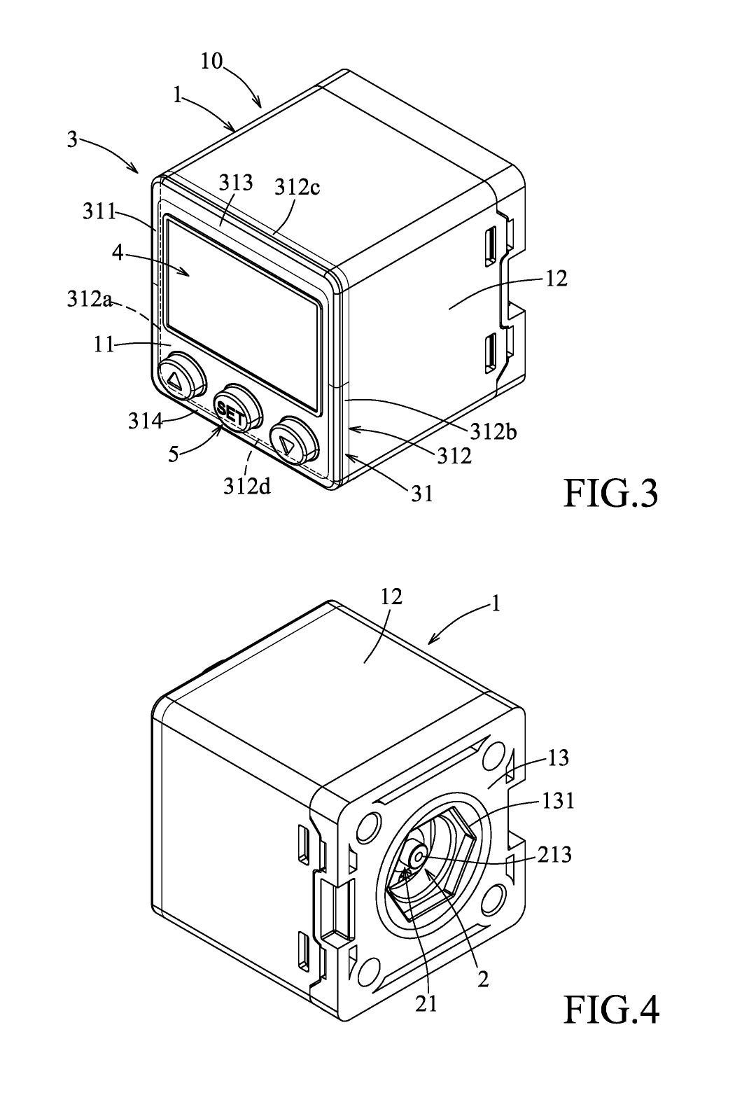

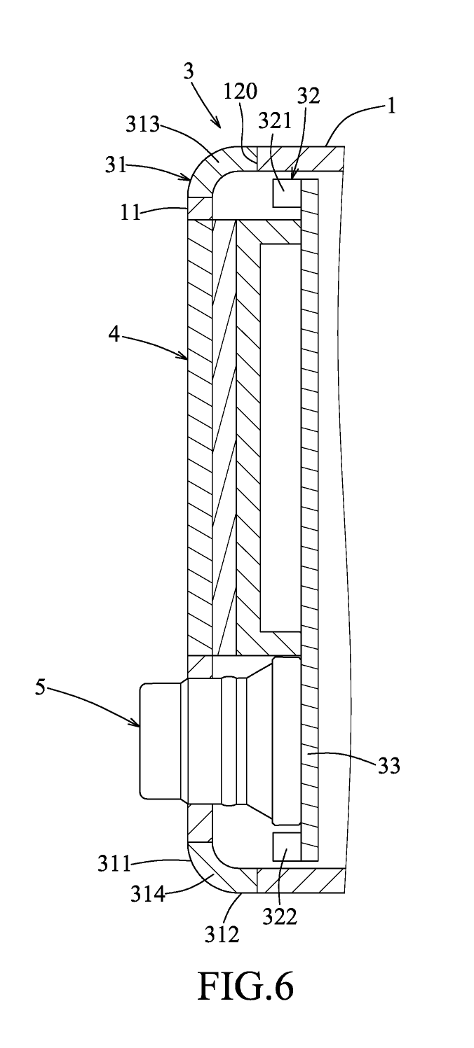

With reference to FIGS. 3 to 6, in this embodiment, the housing 1 is approximately cubical, and has a surrounding wall 12 which defines an accommodating space therein and which extends forwardly to terminate at a front edge 120, a front wall 11 which is disposed forwardly of the surrounding wall 12 to close an open end of the accommodating space, and a rear wall 13 which is disposed rearwardly of the surrounding wall 12 to cover an opposite open end of the accommodating space and which has an opening 131. The sensor module 2 is disposed in the accommodating space of the housing 1, and is configured to detect and measure the operating parameter of the object and to send a measured information so as to produce an instruction set corresponding to the measured information. In this embodiment, the object to be measured is a piping unit in which a fluid flows, and the sensor module 2 is utilized to measure the pressure of the fluid. The sensor module 2 has a sensor unit 21 and a control unit (not shown) electrically connected with the sensor unit 21. The sensor unit 21 has a sensor circuit board 211 which has a penetrating hole (211a) formed therein, a pressure sensing chip 212 which is attached to one major surface of the circuit board 211 to close the penetrating hole (211a) and electrically connected with the circuit board 211, and a duct 213 which is disposed on the other major surface of the circuit board 211 to be in spatial communication with the penetrating hole (211a). The duct 213 has an end extending in the opening 131 to be in fluid communication with the object to be measured through a connector (not shown) for flowing of the fluid into the sensor unit 21 and hence measuring the pressure of the fluid by the pressure sensing chip 212. The measured information is transmitted to the control unit to produce a corresponding instruction set.

With reference to FIGS. 3 to 6, the light signal module 3 is disposed in the accommodating space of the housing 1 and is electrically connected with the sensor module 2. The light signal module 3 is actuated by the instruction set to emit light therefrom. The light signal module 3 has a front light emitting surface 311 and a lateral light emitting surface 312 which respectively face two different directions from each other. In this embodiment, the light signal module 3 includes a translucent lampshade 31 and a light emitting unit 32 disposed within and rearwardly of the translucent lampshade 31. The translucent lampshade 31 defines the front light emitting surface 311 and the lateral light emitting surface 312. The light emitting unit 32 is electrically connected with the control unit of the sensor module 2 to be actuated by the instruction set to emit light through the front and lateral light emitting surfaces 311, 312 of the translucent lampshade 31. Also, the translucent lampshade 31 is integrally formed with and surrounds a periphery of the housing 1 by multi-material injection molding. The translucent lampshade 31 is made from a translucent material in part.

The housing 1 is made from a non-translucent material. The light emitting unit 32 is mounted on a circuit board 33 disposed adjacent to the translucent lampshade 31.

In this embodiment, the translucent lampshade 31 is attached to the front edge 120 of the surrounding wall 12 and the front wall 11 of the housing 1. The front light emitting surface 311 is flush with the front wall 11. The direction that the front light emitting surface 311 faces is substantially perpendicular to the direction that the lateral light emitting surface 312 faces. The translucent lampshade 31 is in the form of a square frame. Specifically, the lateral light emitting surface 312 includes a left light emitting surface portion, a right light emitting surface portion opposite to the left light emitting surface portion, an upper light emitting surface portion, and a lower light emitting surface portion opposite to the upper light emitting surface portion. Also, the translucent lampshade 31 has first and second translucent sections 313, 314 adjoined to each other. In this embodiment, the first and second translucent sections 313, 314 are disposed at upper and lower sides, respectively, to be opposite and adjoined to each other in an upper-and-lower direction and cooperatively define the front and lateral light emitting surfaces 311, 312. The light emitting unit 32 has first and second light emitting assemblies 321, 322 which are disposed at the first and second translucent sections 313, 314, respectively. The light signal module 3 further has a light resist unit (not shown) disposed between the first and second translucent sections 313, 314 to prevent passage of light emitting from the first light emitting assembly 321 through the second translucent section 314, and passage of light emitting from the second light emitting assembly 322 through the first translucent section 313. The instruction set has a plurality of commands. The first light emitting assembly 321 is actuated by one of the commands to emit light through the first translucent section 313. The second light emitting assembly 322 is actuated by another one of the commands to emit light through the second translucent section 314. The light emitted from each of the first and second light emitting assemblies 321, 322 may be red or green in color. That is, each of the first and second light emitting assemblies 321, 322 may emit light having at least one color. The numbers of the translucent sections of the translucent lampshade 31 and the light emitting assemblies of the light emitting unit 32 may be changed depending on different needs, e.g., only one or more than two.

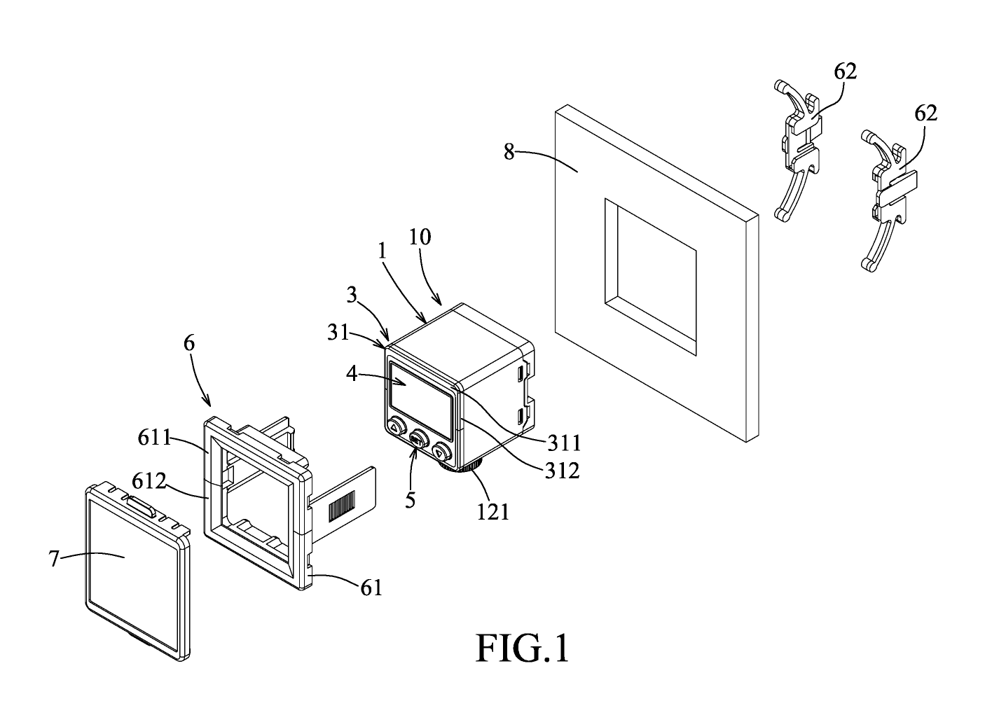

A first signal and a second signal are generated by the control unit in response to the measured information, and are transmitted to a control computer (not shown) through a transmission hole 121 (see FIG. 1) and a transmission line (not shown) so as to respectively control a switch of a first machine (not shown) and a switch of a second machine (not shown). The instruction set is changed depending on the different first and second signals. For example, when the first machine is controlled with the first signal to be an ON state by the control computer, the first light emitting assembly 321 is actuated by the instruction set to emit green light. When the first machine is controlled with the first signal to be an OFF state by the control computer, the first light emitting assembly 321 is actuated by the instruction set to emit red light. When the second machine is controlled with the second signal to be an ON state by the control computer, the second light emitting assembly 322 is actuated by the instruction set to emit green light. When the second machine is controlled with the second signal to be an OFF state by the control computer, the second light emitting assembly 322 is actuated by the instruction set to emit red light. Thus, a user can observe and monitor the switch operation of the first and second machines by seeing front, left and right sides of the light signal module 3 of the sensor 10.

The sensor 10 may include a display module 4 and an input module 5 disposed at the front of the housing 1 and electrically connected with the control unit.

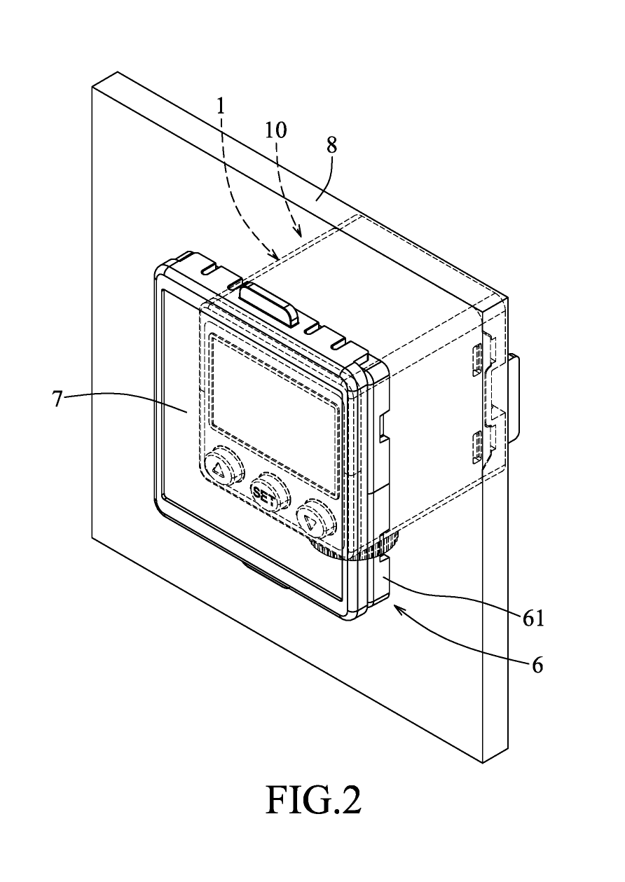

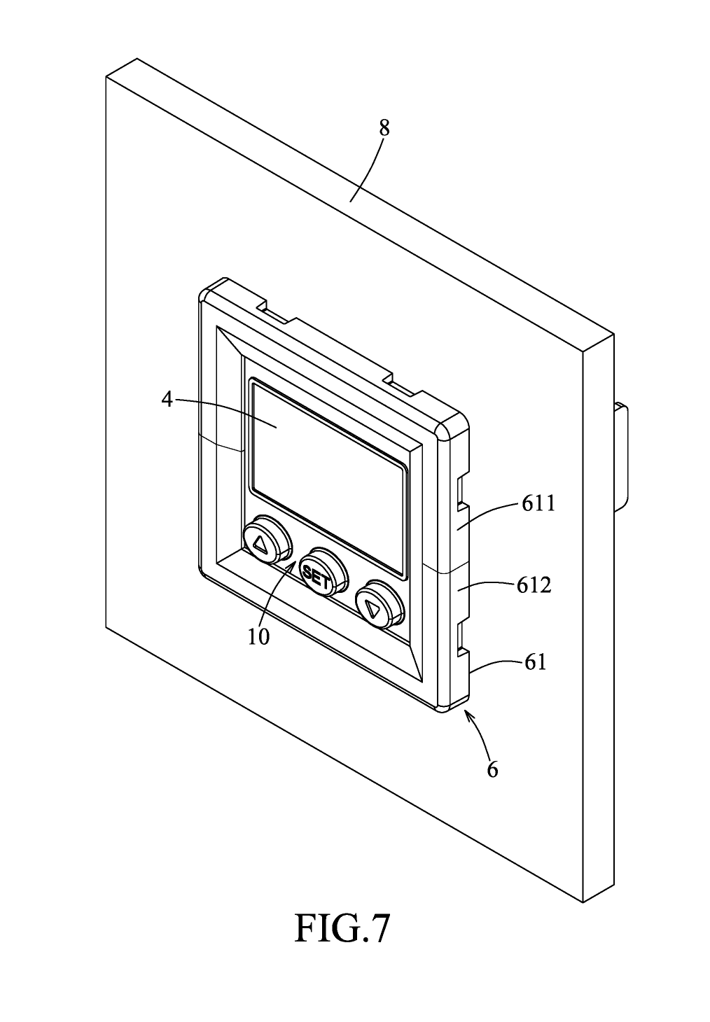

With reference to FIGS. 1, 2, 6 and 7, the fastening unit 6 is disposed to fasten the sensor 10 to the upright wall 8 to permit light emitted from the light signal module 3 through the front and lateral light emitting surfaces 311, 312 to pass therethrough. The fastening unit 6 includes a coupling frame 61 which is made from a translucent material and which is attached to and disposed forwardly of the light signal module 3, and at least one tightening member 62 (two tightening members 62 in this embodiment) which is disposed rearwardly of the upright wall 8 to cooperate with the coupling frame 61 to tighten the housing 1 to the upright wall 8. In this embodiment, the coupling frame 61 has first and second light conduct sections 611, 612 disposed to respectively cover the first and second translucent sections 313, 314. A light resist unit (not shown) is disposed between the first and second light conduct sections 611, 612 to prevent entrance of light emitting from the first translucent section 313 into the second light conduct section 612, and entrance of light emitting from the second translucent section 314 into the first light conduct section 611. The front protective cover 7 is disposed forwardly of the coupling frame 61 and is made from a translucent material for passage of light therethrough.

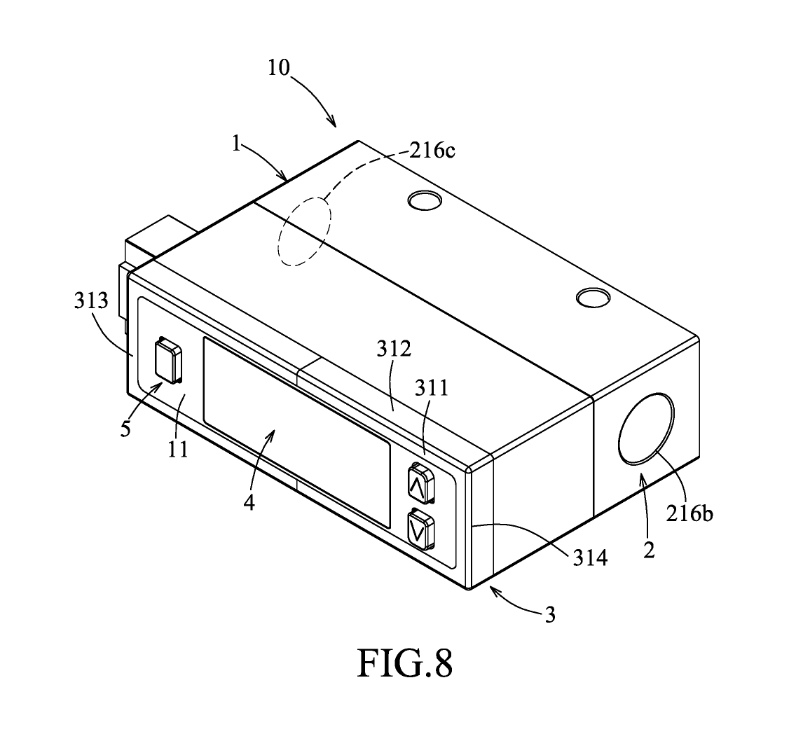

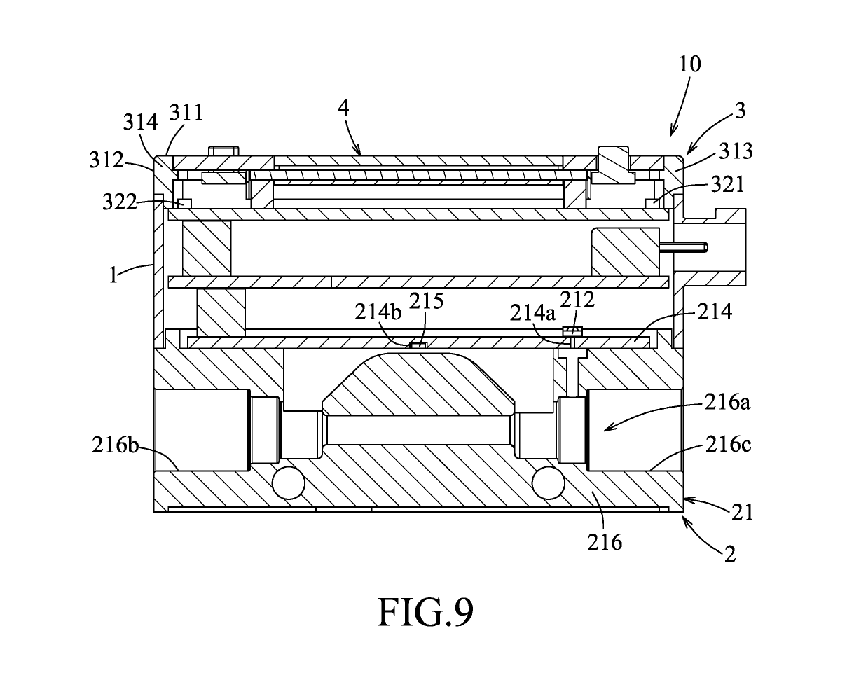

Referring to FIGS. 8 and 9, in a second embodiment, the housing 1 of the sensor 10 has a rectangular cross-section. The sensor module 2 is utilized to measure the pressure and the flow rate of the fluid flowing in the object to be measured. The sensor module 2 has a sensor unit 21 and a control unit (not shown) electrically connected with the sensor unit 21. The sensor unit 21 has a sensor circuit board 214 which has a penetrating hole (214a) and a recess (214b) formed therein, a pressure sensing chip 212 which is attached to one major surface of the circuit board 214 to close the penetrating hole (214a) and electrically connected with the circuit board 214, a fluid flow sensing chip 215 which is embedded in the recess (214b) and electrically connected with the circuit board 214, and a duct member 216 which has a duct (216a) formed therein, The duct (216a) has a fluid inlet (216b) and a fluid outlet (216c), and is in fluid communication with the penetrating hole (214a) and the recess (214b). The piping unit of the object is connected with the fluid inlet (216b) and the fluid outlet (216c) to form a flow route such that the fluid flow sensing chip 215 and the pressure sensing chip 212 are disposed on route for respectively detecting and measuring the flow rate and the pressure of the fluid flowing in the object. The measured information is transmitted to the control unit to produce a corresponding instruction set.

In this embodiment, the light signal module 3 is in the form of a rectangular frame, and the first and second translucent sections 313, 314 are disposed opposite to and adjoined to each other in a left-and-right direction (The first translucent section 313 is at a left side while the second translucent section 314 is at a right side).

Moreover, the light emitting unit 32 is disposed to generate a first light with a first color and a second light with a second color that is different from the first color. The measured information has a measured value. The sensor module 2 has a first predetermined value built therein such that the light emitting unit 32 is actuated by the instruction set to emit the first light with the first color on condition that the measured value is smaller than the first predetermined value, and such that the light emitting unit 32 is actuated by the instruction set to emit the second light with the second color on condition that the measured value is equal to or larger than the first predetermined value. Also, the light emitting unit 32 is disposed to further generate a third light with a third color that is different from both the first and second colors. The sensor module 2 has a second predetermined value built therein and larger than the first predetermined value such that the light emitting unit 32 is actuated by the instruction set to emit the second light with the second color on condition that the measured value is equal to or larger than the first predetermined value and smaller than the second predetermined value, and such that the light emitting unit 32 is actuated by the instruction set to emit the third light with the third color on condition that the measured value is equal to or larger than the second predetermined value.

For example, in the second embodiment, the first color is green, the second color is orange, and the third color is red. The measured information has a value representing a pressure of the object and shown on a left side of the display module 4, and another value representing a flow rate of the object and shown on a right side of the display module 4. The sensor module 2 further has a third predetermined value built therein and a fourth predetermined value built therein and larger than the third predetermined value. The predetermined values are built in the control unit by a user input from the input module 5. When the pressure value is smaller than the first predetermined value, the first light emitting assembly 321 is actuated by one command of the instruction set to emit the green light (the first light). When the pressure value is equal to or larger than the first predetermined value but smaller than the second predetermined value, the first light emitting assembly 321 is actuated by one command of the instruction set to emit the orange light (the second light). When the pressure value is equal to or larger than the second predetermined value, the first light emitting assembly 321 is actuated by one command of the instruction set to emit the red light (the third light). On the other hand, when the flow rate value is smaller than the third predetermined value, the second light emitting assembly 322 is actuated by one command of the instruction set to emit the green light (the first light). When the flow rate value is equal to or larger than the third predetermined value but smaller than the fourth predetermined value, the second light emitting assembly 322 is actuated by one command of the instruction set to emit the orange light (the second light). When the flow rate value is equal to or larger than the fourth predetermined value, the second light emitting assembly 322 is actuated by one command of the instruction set to emit the red light (the third light). Thus, a user can monitor the pressure and flow rate of the object by seeing front, upper and lower sides of the light signal module 3 of the sensor 10.

The various aspects of the light signal module 3 can deviate from the example shown and described herein. For example, the light signal module may be configured to blink or to be lighted to alarm a user. Each of the first and second light emitting assemblies 321, 322 is configured by an LED capable of emitting light of various colors. In the modified forms, each of the first and second light emitting assemblies 321, 322 may have a plurality of LEDs capable of emitting light with various colors.

Furthermore, in the above embodiments, the light signal module 3 is configured to surround the housing 1. Alternatively, the light signal module 3 may be formed as an elongated strip, or any form having the front and lateral light emitting surfaces 311, 312.

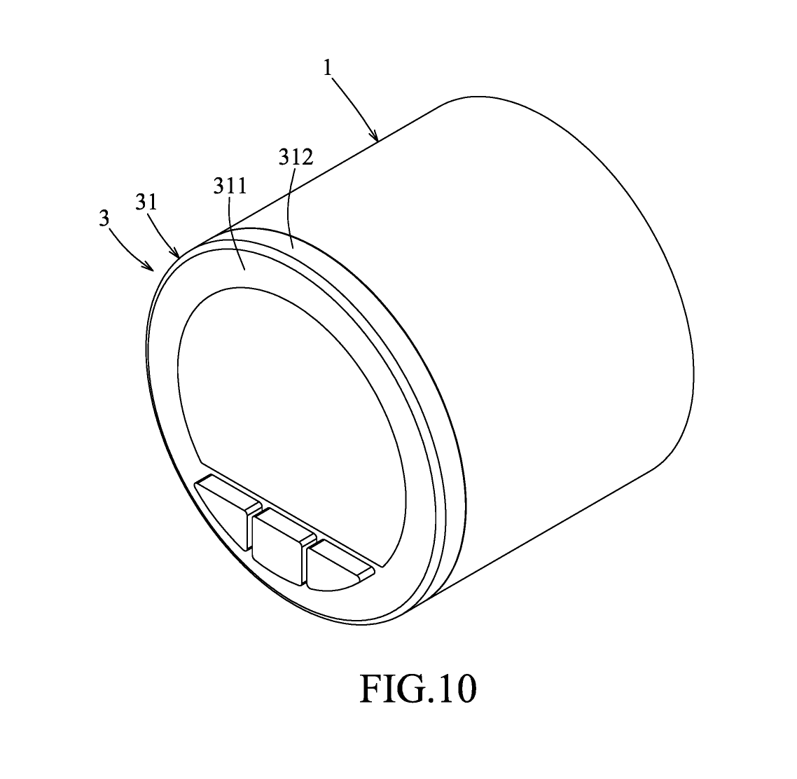

With reference to FIGS. 3, 8 and 10, the housing 1 is configured to have the front wall 11 formed to accommodate the light signal module 3. The front wall 11 is cubical in the first and second embodiments. Alternatively, the housing 1 may have a circular front wall 11, or the front wall 11 may be dispensed therewith for exposing the front light emitting surface 311 instead. As shown in FIG. 10, the translucent lampshade 31 is in the form of a circular frame. The lateral light emitting surface 312 is in the form of a circular ring. The front light emitting surface 311 is disposed to close the accommodating space of the housing 1. Furthermore, the front wall 11 of the housing 1 may be polygonal in shape.

As illustrated, according to the sensor 10 of the disclosure having front and lateral light emitting surfaces 311, 312 which respectively face two different directions from each other, a user can easily see the light signal module 3 for facilitating monitoring of a machine or an object. With the sensor module 2 capable of producing the instruction set corresponding to the measured information to actuate the light signal module 3 to emit light, the user can readily get the measured information from the light signal module 3. Furthermore, with the coupling frame 61 and the front protective cover 7 made from a translucent material, the light emitted from the light signal module 3 can pass therethrough.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A sensor for measuring an object, comprising:
a housing;
a sensor module disposed in said housing and configured to detect the object and to send a measured information so as to produce an instruction set corresponding to the measured information; and
a light signal module disposed in said housing and electrically connected with said sensor module, said light signal module being actuated by the instruction set to emit light therefrom, said light signal module having a front light emitting surface and a lateral light emitting surface which respectively face two different directions from each other.

2. The sensor as claimed in claim 1, wherein said light signal module includes a translucent lampshade and a light emitting unit disposed within and rearwardly of said translucent lampshade, said translucent lampshade defining said front light emitting surface and said lateral light emitting surface, said light emitting unit being actuated by the instruction set to emit light through said front and lateral light emitting surfaces of said translucent lampshade.

3. The sensor as claimed in claim 2, wherein said translucent lampshade is configured to surround a periphery of said housing.

4. The sensor as claimed in claim 3, wherein the direction that said front light emitting surface faces is substantially perpendicular to the direction that said lateral light emitting surface faces.

5. The sensor as claimed in claim 4, wherein said translucent lampshade is in form of a square frame, said lateral light emitting surface including a left light emitting surface portion, a right light emitting surface portion opposite to said left light emitting surface portion, an upper light emitting surface portion, and a lower light emitting surface portion opposite to said upper light emitting surface portion.

6. The sensor as claimed in claim 4, wherein said translucent lampshade is in form of a circular frame, said lateral light emitting surface being in form of a circular ring.

7. The sensor as claimed in claim 2, wherein said housing has a surrounding wall which defines an accommodating space therein for accommodating said sensor module and said light signal module and which extends to terminate at a front edge, and a front wall which is disposed forwardly of said surrounding wall, said translucent lampshade being attached to said front edge such that said front light emitting surface is flush with said front wall.

8. The sensor as claimed in claim 2, wherein said light emitting unit is disposed to generate a first light with a first color and a second light with a second color that is different from the first color, the measured information having a measured value, said sensor module having a first predetermined value built therein such that said light emitting unit is actuated by the instruction set to emit the first light with the first color on condition that the measured value is smaller than the first predetermined value, and such that said light emitting unit is actuated by the instruction set to emit the second light with the second color on condition that the measured value is equal to or larger than the first predetermined value.

9. The sensor as claimed in claim 8, wherein said light emitting unit is disposed to further generate a third light with a third color that is different from both the first and second colors, said sensor module having a second predetermined value built therein and larger than the first predetermined value such that said light emitting unit is actuated by the instruction set to emit the second light with the second color on condition that the measured value is equal to or larger than the first predetermined value and smaller than the second predetermined value, and such that said light emitting unit is actuated by the instruction set to emit the third light with the third color on condition that the measured value is equal to or larger than the second predetermined value.

10. The sensor as claimed in claim 2, wherein said translucent lampshade has first and second translucent sections adjoined to each other, said light emitting unit having first and second light emitting assemblies which are disposed at said first and second translucent sections, respectively, the instruction set having a plurality of commands, said first light emitting assembly being actuated by one of the commands to emit light through said first translucent section, said second light emitting assembly being actuated by another one of the commands to emit light through said second translucent section.

11. The sensor as claimed in claim 10, wherein said first and second translucent sections are disposed opposite to and adjoined to each other in an upper-and-lower direction.

12. The sensor as claimed in claim 10, wherein said first and second translucent sections are disposed opposite to and adjoined to each other in a left-and-right direction.

13. The sensor as claimed in claim 1, wherein said housing is configured to be mounted on an upright wall, said sensor further comprising a fastening unit which is disposed to fasten said housing to the upright wall, and which is configured to permit light emitted from said light signal module through said front and lateral light emitting surfaces to pass therethrough.

14. The sensor as claimed in claim 13, wherein said housing has a surrounding wall which defines an accommodating space therein for accommodating said sensor module and said light signal module and which extends to terminate at a front edge, and a front wall which is disposed forwardly of said surrounding wall, said light signal module being attached to said front edge such that said front light emitting surface is flush with said front wall.

15. The sensor as claimed in claim 14, wherein said fastening unit includes a coupling frame which is made from a translucent material and which is attached to and disposed forwardly of said light signal module, and at least one tightening member which is disposed rearwardly of the upright wall to cooperate with said coupling frame to tighten said housing to the upright wall.

16. The sensor as claimed in claim 15, further comprising a front protective cover which is disposed forwardly of said coupling frame and which is made from a translucent material.
